(19) United States
(12) Patent Application Publication
(10) Pub. No.: US 2009/0191510 A1
(43) Pub. Date: Jul. 30, 2009

(54) Periodontal treatment employing applied ultrasonic energy

(75) Inventor: Robert K. Larsen, Sandy, UT (US)

Correspondence Address: GEOFFREY E. DOBBIN, PATENT ATTORNEY, 4278 SOUTH 6220 WEST, WEST VALLEY CITY, UT, 84128-6501, US

(73) Assignee: Cao Group, Inc., West Jordan, UT (US)

(21) Appl. No.: 11/473,383

(22) Filed: Jun. 22, 2006

Related U.S. Application Data
(60) Provisional application No. 60/692,720, filed on Jun. 22, 2005.

(51) Int. Cl. A61C 5/00

(52) U.S. Cl. 433/215

(57) ABSTRACT

A method for treating periodontal disease. A dental substance is applied to gingival tissues by use of ultrasonic energy for improved exposure and treatment results.

### CLAIM FOR PRIORITY

This patent application claims priority to and benefit of U.S. Provisional Patent Application Ser. No. 60/692,720 filed on Jun. 22, 2005.

### BACKGROUND

Periodontal disease is a common ailment among the human population. The disease results from the presence of certain bacteria in the oral environment that take up residence in the periodontal pocket, the space between the gum tissue and the tooth below the gum line. These particular bacteria produce toxins that cause inflammation of the surrounding tissue. This enflamed tissue is painful for the patient, but also increases the absorptive ability of this tissue, allowing these and other toxins to more readily enter the bloodstream. Recent studies have indicated a link between the presence of periodontal disease in the oral environment and more systemic cardiovascular conditions within the human body. The need to treat and manage periodontal disease becomes even more important where this link to systemic conditions is established. Additionally, this inflammation causes the periodontal pockets to increase in size, allowing other bacteria and materials to enter the pockets. This situation allows for a more rapid degradation of the tooth structure and underlying alveolar bone structure, leading to tooth loss.

### DETAILED DESCRIPTION

Due to the nature and location of periodontal disease and the related periodontitis, improved methods are needed to penetrate to, and then treat the bacteria responsible for causing the disease. A system has been created to efficiently deliver an antimicrobial material to the periodontal spaces, either used independently or in conjunction with a device employing the application of ultrasonic energy to enhance the activity and penetration ability of the treatment material into the periodontal spaces.

The desired antimicrobial material can be applied as a single composition, or the active ingredients can be delivered in separate compositions administered in successive stages. The primary or active ingredients of the antimicrobial material can include but are not limited to: bacteriostats, bacteriocides, and related antimicrobial agents; essential oils; reaction enhancers; peroxides, perborates, percarbonates, and other oxiding agents; pain management compounds or materials intended to reduce the sensitivity of gum or tooth structures. The composition may also include solubilizing, surfactant, or thickening agents, flavors, colors, fillers, and vitamins and minerals. The device employed to deliver ultrasonic energy to the antimicrobial composition(s) may deliver said energy using an extension of the device that may be formed in the shape of an arch, point, tip, strip, block, patch, or other configuration. The ultrasonic energy may be of a frequency from 20 kHz to 1.5 MHz.

The antimicrobial agents may include chlorhexidine and compounds of chlorhexidine, benzethonium chloride, cetylpyridinium chloride, glutaraldehyde, domiphen bromide, quaternary ammonium salts, zinc compounds, xylitol, sanguinanine soluble pyrophosphates, fluoride compounds, alexidine, octonidine, EDTA, and triclosan.

The essential oils may contain thymol, menthol, eucalyptol, methyl salicilate, carvacrol, camphor, anethole, carvone, eugenol, isoeugenol, limonene, osimen, n-decyl alcohol, citronel, a-salpineol, methyl acetate, citronellyl acetate, methyl eugenol, cineol, linalool, ethyl linalaol, safrola vanillin, spearmint oil, peppermint oil, lemon oil, orange oil, sage oil, rosemary oil, cinnamon oil, pimento oil, laurel oil, cedarleaf oil, and clove oil.

Reaction enhancers are materials that are more useful for multi-component systems when used in conjunction with the oxidizing agents, for the purpose of increasing the rate of reaction or activity of the system. Reaction enhancers may include materials that increase the pH of the complete system such as salts of hydroxides or carbonates, or reducing materials such as salts of iodide, iron, zinc, copper, permanganates, and sulfites.

The oxidizing agents may include any member of a class of peroxides such as hydrogen peroxide or urea peroxide, and any salts of percarbonates and perborates.

Substances for providing pain management or reducing sensitivity may include benzocaine, lidocaine, or potassium nitrate, citric acid, citric acid salts, and strontium chloride.

Solubilizing, surfactant, or thickening agents may include any of a variety of molecular weights of polyethylene glycol (polyethylene oxide), polypropylene glycol, polyvinyl pyrrolidone, polyacrylic acid (Carbopol), polyvinyl alcohol, cellulosic compounds such as hydroxyethyl cellulose and carboxymethyl cellulose, natural gums such as gum karaya, xanthan gum, Guar gum, gum arabic, and gum tragacanth, delmopinol, “Pemulen” made by B. F. Goodrich Company, acids or alcohols of long chain hydrocarbons with a carbon member from C.sub.10-30, polysorbates, polaxamers, higher fatty acid monoglyceride monosulfates, as sodium salts of the monosulfated monoglycerides; or hydrogenated coconut oil fatty acids, higher alkylsulfates, such as sodium lauryl sulfate and alkyl aryl sulfonates, such as sodium dodecyl benzene sulfonate, propylene glycol, low molecular weight polyethylene glycol, and any block copolymers of the above mentioned.

Whether prepared as a single composition, or as multiple compositions, the treatment compound is applied either to a containment appliance, or directly to the teeth and surrounding gum tissue. If employed, the ultrasonic device is then applied to the teeth and surrounding gum tissue. Whether or not ultrasonic energy is applied to the composition, the treatment is conducted for a specified time, anywhere between 2-30 minutes. The ultrasonic device, if employed, and the composition are then removed from the oral environment. Any residual compound may then be rinsed out or otherwise removed from the oral cavity. The rinse process also aids in the removal of live or dead bacteria, and any residual toxins or components resulting from the destruction of these bacteria.

This process may be repeated for multiple applications of either the single composition, or any part of the multiple composition arrangement. The application of ultrasonic energy serves two purposes: 1) To promote the movement and migration of the treatment composition around the tooth structure and into the periodontal pockets and other spaces below the gum line, and 2) to increase the rate of reaction between the active ingredients within the composition and the targeted bacteria found within these locations in the oral environment. Where the active ingredients are prepared in multiple compositions, the individual parts may be employed separately, or may be combined in any combination or all together when applied for an individual ultrasonic treatment.

### Example Formula #1

50-75%—water
0.1-0.5%—sodium saccharin
10-15%—polyethylene glycol 400,000
0.1-0.4%—peppermint oil
5-15%—aqueous hydrogen peroxide 50%
10-20%—glycerin
0.05-1.0%—essential oils

### Example Formula #2

75-90%—water
0.1-0.5%—sodium saccharin
0.1-0.5%—methyl salicilate
0.5-5%—Carbopol 934
0.1-4%—reaction enhancers
5-15%—glycerin
0.5-5%—propylene glycol
0.05-1.0%—essential oils

### Example Formula #3

75-90%—water
0.1-1%—flavoring agents
2-20%—thickeners/solubilizers
0.05-0.5%—anti-microbials
0.1-5%—desensitizer

### Example Formula #4

60-90%—water
0.1-0.8%—flavoring agents
15%—polyvinylpyrrolidone
3-15%—solubilizing agent
0.05-0.5%—anti-microbials
0.05-0.5%—essential oils
0.05-1.0%—pain management agent

### Example Formula #5

80-90%—water
2-15%—surfactants/solubilizers
0.1-0.5%—essential oils
0.1-1.5%—anti-microbials
0.05-1.0%—pain management agent

### Example Formula #6

65-85%—water
2-10%—thickening agent
5-15%—oxidizing agent
0.1-1.0%—flavoring agents
3-10%—propylene glycol
0.1-2%—essential oils
0.1-1.0%—pain management agent
0.1-1%—citric acid

While the present invention has been described and illustrated in conjunction with a number of specific embodiments, those skilled in the art will appreciate that variations and modifications may be made without departing from the principles of the invention as herein illustrated, described, and claimed. The present invention may be embodied in other specific forms without departing from its spirit or essential characteristics. The described embodiments are to be considered in all respects as only illustrative, and not restrictive. All changes which come within the meaning and range of equivalency of the claims are to be embraced within their scope.

I claim:

1. A method for providing a dental patient with periodontic treatment comprising the steps of:
placing an oral composition for delivery to periodontal spaces of a human patient's oral cavity,
applying ultrasonic energy to said oral composition, and
permitting said oral composition to perform its intended function.

2. A method as recited in claim 1 wherein said oral composition includes an antimicrobial material.

3. A method as recited in claim 1 wherein said step of applying ultrasonic energy enhance penetration of said oral composition into periodontal spaces.

4. A method as recited in claim 2 wherein said antimicrobial material includes an ingredient selected from the group consisting of bacteriostats, and bacteriocides.

5. A method as recited in claim 1 further comprising the step of exposing said periodontal spaces to a material selected from the group consisting of essential oils, reaction enhancers, peroxides, perborates, percarbonates, oxidizing agents, pain management compounds, and sensitivity reducers.

6. A method as recited in claim 1 wherein said step of applying ultrasonic energy is performed by utilizing a probe placed into the oral cavity.

7. A method as recited in claim 6 wherein said probe has a shape selected from the group consisting of arch, point, tip, strip, block, and patch.

8. A method as recited in claim 1 wherein said ultrasonic energy has a frequency in the range of from 20 kHz to 1.5 MHz.

9. A method as recited in claim 2 wherein said antimicrobial agent includes a material selected from the group consisting of chlorhexidine, benzethonium chloride, cetylpyridinium chloride, glutaraldehyde, domiphen bromide, quaternary ammonium salts, zinc compounds, xylitol, sanguinanine soluble pyrophosphates, fluoride compounds, alexidine, octonidine, EDTA, and triclosan.

10. A method as recited in claim 1 wherein said oral composition includes at least one essential oil is selected from the group consisting of thymol, menthol, eucalyptol, methyl salicilate, carvacrol, camphor, anethole, carvone, eugenol, isoeugenol, limonene, osimen, n-decyl alcohol, citronel, a-salpineol, methyl acetate, citronellyl acetate, methyl eugenol, cineol, linalool, ethyl linalaol, safrola vanillin, spearmint oil, peppermint oil, lemon oil, orange oil, sage oil, rosemary oil, cinnamon oil, pimento oil, laurel oil, cedarleaf oil, and clove oil.

11. A method as recited in claim 1 further comprising the step of placing a reaction enhancer into one of said periodontal spaces.

12. A method as recited in claim 11 wherein said reaction enhancer serves to increase the pH of materials in said periodontal spaces.

13. A method as recited in claim 11 wherein said reaction enhancer is selected from the group consisting of hydroxides, carbonates, iodide, iron, zinc, copper, permanganates, and sulfites.

14. A method as recited in claim 1 further comprising the step of placing an oxidizing agent into a periodontal space.

15. A method as recited in claim 14 wherein said oxidizing agent is selected from the group consisting of hydrogen peroxide, urea peroxide, percarbonates and perborates.

16. A method as recited in claim 1 wherein said step of applying ultrasonic energy is performed for a period of from 2 to 30 minutes.

17. A method as recited in claim 1 wherein said step of applying ultrasonic energy serves to promote movement and migration of said oral composition into periodontal spaces.

18. A method as recited in claim 1 wherein said step of applying ultrasonic energy serves to increase the rate of reaction between the active ingredients within said oral composition and any targeted bacteria.
